(19) United States
(12) Patent Application Publication
(10) Pub. No.: US 2010/0111994 A1
(43) Pub. Date: May 6, 2010

(54) ANTI-BACTERIAL COMPOSITION AND METHOD OF USING SAME

(75) Inventors: Francis Tufaro, St. Petersburg, FL (US); Akiko Tanaka, Clearwater, FL (US); Michael P. Burrows, Largo, FL (US); William G. Bradley, Lutz, FL (US); Joanna Peterkin, Rancho Santa Fe, CA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: Allera Health Products, Inc., St. Petersburg, FL (US)

(21) Appl. No.: 12/478,157

(22) Filed: Jun. 4, 2009

Related U.S. Application Data
(60) Provisional application No. 61/058,775, filed on Jun. 4, 2008.

(51) Int. Cl. A01N 65/06

(52) U.S. Cl. 424/195.18

(57) ABSTRACT

Disclosed is an alkaline extract of pine cones with anti-bacterial activity.

### RELATED APPLICATIONS

This application claims priority to U.S. Ser. No. 61/058,775, filed Jun. 4, 2008, which is incorporated herein by reference in its entirety.

### FIELD OF THE INVENTION

The invention generally relates to anti-bacterial compositions and more particularly to alkaline extracts of plants that are useful for inhibiting bacterial growth.

### BACKGROUND OF THE INVENTION

Although many anti-microbial agents have been described, undesired bacterial growth continues to present profound challenges to the pharmaceutical, cosmetic, and food industries. There remains a need to identify additional anti-bacterial agents.

### SUMMARY OF THE INVENTION

The present invention is based, in part, upon the discovery that alkaline extracts of pine cones inhibit the growth of several species of bacteria. Accordingly, the invention provides compositions and methods useful for inhibiting the growth of bacteria. The compositions and methods of the invention can be used to inhibit the growth of bacteria in substances such as cosmetics, pharmaceutical products, and food.

In one aspect, the invention provides a composition useful for inhibiting the growth of bacteria. The composition includes a safe and effective dose of a bacteriostatic or bactericidal extract obtained by extraction of plant material with an alkaline solution. The extract comprises one or more phenolic polymers. Optionally, the composition is provided in a carrier which is suitable for topical application to skin or a mucous membrane of a mammal.

In another aspect, the invention provides methods of inhibiting bacterial growth in a substance or area. In the method a composition comprising a safe and effective dose of an anti-bacterial extract obtained by extraction of plant material with an alkaline solution as described herein is contacted with a substance in which inhibition of bacterial growth is desired.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only and not intended to be limiting.

Other features and advantages of the invention will be apparent from the following detailed description and claims.

### BRIEF DESCRIPTION OF THE DRAWINGS

FIG. 1 is a flow chart showing purification of a bacteriostatic or bactericidal extract according to the invention.

FIG. 2 is a histogram showing the bacterial count (E. coli) following exposure to various concentrations of PPC.

FIG. 3 is a is a histogram showing the bacterial count (E. coli, S. aureus, and MRSA) following exposure to various concentrations of PPC.

FIG. 4 is a graph of a fluorometric assay showing bacteria/ml (E. coli) as a function of log percentage PPC in the presence and absence of serum.

FIG. 5 is a graph of a fluorometric assay showing bacteria/ml (E. coli and MRSA) as a function of log percentage PPC.

FIG. 6 is a histogram of a fluorometric assay showing E. coli/ml at decreasing concentrations of PPC (reading left to right).

FIG. 7 is a histogram of a fluorometric assay showing P. acnes/ml at decreasing concentrations of PPC (reading left to right).

FIG. 8A is a schematic diagram showing the preparation of an acid-precipitate and supernatant fraction of a powered proligna composition.

FIG. 8B is a graph showing the results of a 24 hour cytotoxicity assay using increasing amounts of PPC taken from a reference PPC isolate and from the acid ppt PC6 and the pellet PC7 fraction.

FIG. 9 is a histogram comparing no PPC (0%), PPC 1% fraction >10 kDa, and 1% PPC<10 kDA (indicated as PPC1%>10 and PPC1%<10, respectively).

FIG. 10 is a graph showing the results of a kinetic assay showing the effect of 4% PPC and 8% PPC plotting bacteria/ml as a function of minutes of PPC treatment.

FIG. 11 is a graph showing the effect of methanol on the anti-bacterial activity of PPC in a 24 hour cytotoxicity assay.

FIG. 12 is a histogram showing the results of examining the bacterial cytotoxicity of PPC when combined with a gel, a creams, or a handwash for topical application to a subject.

FIG. 13 is a histogram showing results from a fluorometric assay of E. coli/ml using handwash or cream and the indicated concentrations of PPC.

FIG. 14 is a histogram showing results from a fluorometric assay of P. acne/ml using handwash or cream and the indicated concentrations of PPC.

### DETAILED DESCRIPTION OF THE INVENTION

Anti-bacterial substances according to the invention are prepared by adapting previously described methods for isolating bioactive plant material with an alkaline solution. Such methods are described in, for example, Tanaka et al., US20070166407, U.S. Pat. No. 6,703,053 and U.S. Pat. No. 6,866,875. Typically, the anti-bacterial extract will include one or more phenolic polymers. In some embodiments, the composition is provided as an active component of a polyphenylpropenoid-polysaccharide complex (PPC).

By “bacteriostatic” is meant the inhibition of growth or replication or proliferation or reproduction of the targeted bacterium. By “bacteriocidal” is meant the killing of bacteria. For convenience bacteriostatic and bactericidal will be referred to as “anti-bacterial compositions” unless otherwise indicated.

To monitor the purity and activity of fractions isolated during the purification, anti-bacterial activity can be assessed using assays known in the art and those described in more detail below.

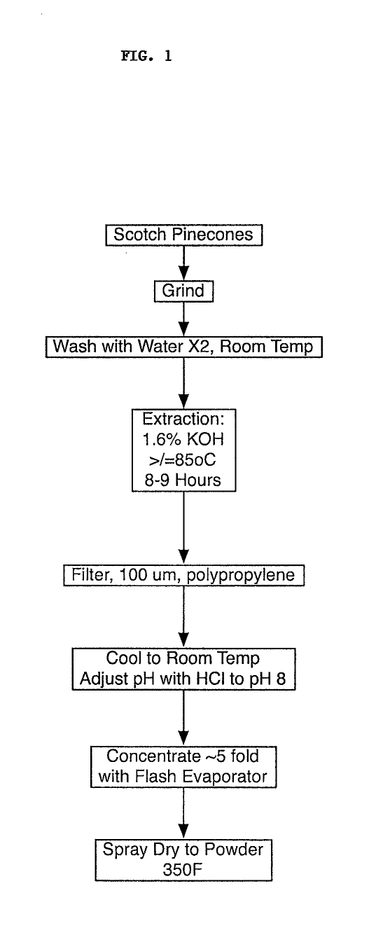

A suitable purification scheme is shown in FIG. 1. The purification scheme results in a dry powder. Thus, in one aspect, the present invention features an anti-bacterial composition that can be provided in a dry, or lyophilized form, for example, as a powder.

The anti-bacterial substance can be obtained from any suitable plant material. For example, the plant material can be, e.g., cones, leaves, needles, bark, stalks, and sheath. Types of plants include, e.g., pine tree, a magnolia tree, bamboo tree, palm tree, Spanish moss, orange pekoe tea, pekoe black tea, green tea, mountain araucaria, and bushy bluestem.

A preferred source is pine cones of any variety or species of genus Pinus, e.g., P. silvestris, P. densiflora, P. koraiensis, P. parviflora and P. thunbergii. Additional pine cone species are listed in Table 1 of U.S. Pat. No. 6,866,875, the contents of which are incorporated by reference in their entirety.

In general, any alkaline solution can be used as long as it can be used to produce an extract with anti-bacterial activity. The alkaline agent can be, e.g., aluminum hydroxide, magnesium hydroxide, aluminum hydroxide/magnesium hydroxide co-precipitate, aluminum hydroxide/sodium bicarbonate co-precipitate, aluminum glycinate, calcium acetate, calcium bicarbonate, calcium borate, calcium carbonate, calcium citrate, calcium gluconate, calcium glycerophosphate, calcium hydroxide, calcium lactate, calcium phthalate, calcium phosphate, calcium succinate, calcium tartrate, dibasic sodium phosphate, dipotassium hydrogen phosphate, dipotassium phosphate, disodium hydrogen phosphate, disodium succinate, magnesium acetate, magnesium aluminate, magnesium borate, magnesium bicarbonate, magnesium carbonate, magnesium citrate, magnesium gluconate, magnesium hydroxide, magnesium lactate, magnesium metasilicate aluminate, magnesium oxide, magnesium phthalate, magnesium phosphate, magnesium silicate, magnesium succinate, magnesium tartrate, potassium acetate, potassium carbonate, potassium bicarbonate, potassium borate, potassium citrate, potassium hydroxide, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium sesquicarbonate, sodium succinate, sodium tartrate, sodium tripolyphosphate, synthetic hydrotalcite, tetrapotassium pyrophosphate, tetrasodium pyrophosphate, tripotassium phosphate, trisodium phosphate, and mixtures thereof.

The alkaline solution will typically be present at a concentration of from about 0.05% w/w to about 25% w/w. In some embodiments, the concentration is about 0.1% w/w to about 20% w/w, about 0.2% w/w to about 15% w/w, 0.5% w/w to about 10% w/w, about 1.0% w/w to about 5% w/w, about 1.25% to about 2.5%. In other embodiments, the concentration is about 0.1% to about 2% w/w.

Preferably, the alkaline solution has a pH of at least about 8, e.g. from about 8 to about 13, from about 9 to about 12, or from about 10 to about 11.

In certain embodiments, the extract includes potassium, e.g., potassium hydroxide. When potassium hydroxide is used it is a 1% solution of potassium hydroxide. The potassium hydroxide can have a pH of, e.g., pH 6 to 8. Preferably, the potassium hydroxide has a pH at least of 8.

In some embodiments, the anti-bacterial composition is a polyphenylpropenoid-polysaccharide complex (PPC). For example, the PPC may have a brown color with an absorption shoulder at 260-280 nm, dissolve in water and alcohol, and acetone, and be composed of a complex of polysaccharides and polyphenylpropenoids, with the five major components having a molecular weight of greater than about 100, 21.0, 13.5, 3.6 and 2.1 kilo Daltons as determined by fast protein liquid chromatography.

In another aspect, the invention includes a plant extract obtained by heat extracting defatted ground plant material with an alkaline solution comprising an alkaline agent. Particulate matter with an average particle size greater than about 0.2 μm is removed, leaving a supernatant. The supernatant is filtered and the pH of the resulting supernatant is adjusted to about 6.0 to about 8.0. The supernatant is concentrated and then dried. Preferably, the supernatant is filtered to obtain a retentive fraction to remove particles with an average molecular mass of less than about 10 kDa. The retentive fraction is then resuspended in an aqueous solvent having a pH of about 6 to about 8 comprising an alkaline agent.

For inducing anti-bacterial activity the composition can provided in a carrier that is suitable for topical application to skin or a mucous membrane of a mammal.

In some embodiments, the extract is provided lyophilized, e.g. as a powder.

In some embodiments, the carrier further comprises an emulsifier and water. The carrier can be, e.g., an emulsion, cream, lotion, gel, oil, ointment, suspension, aerosol spray, powder, aerosol powder, or semi-solid formulation.

If desired, the anti-bacterial composition of the invention can be provided with an anti-inflammatory agent. Examples of these include, e.g., prednisone, dexamethasone, hydrocortisone, estradiol, triamcinolone, mometasone, fluticasone, clobetasol, and non-steroidal anti-inflammatories, such as, for example, acetaminophen, ibuprofen, naproxen, adalimumab and sulindac, or a vasoactive antiproliferative, such as prostacyclin or prostacyclin analogs. Other examples of these agents include those that block cytokine activity or inhibit binding of cytokines or chemokines to the cognate receptors to inhibit pro-inflammatory signals transduced by the cytokines or the chemokines. Representative examples of these agents include, but are not limited to, anti-IL1, anti-IL2, anti-IL3, anti-IL4, anti-IL8, anti-IL15, anti-IL18, anti-MCP1, anti-CCR2, anti-GM-CSF, and anti-TNF antibodies.

The anti-bacterial composition may in addition be provided with a second bacteriostatic or bactericidal agent. In general any suitable bacteriostatic agent can be used. Some examples include, e.g., amphotericin B, carbol-fuchsin, ciclopirox, terbinafine, econazole, haloprogin, ketoconazole, mafenide, miconazole, naftifine, nystatin, oxiconazole, silver sulfadiazine, sulconazole, tioconazole, tolnaftate, and undecylenic acid.

An anti-bacterial composition of the invention can be provided as a dermatological and cosmetic composition. Preferably, the composition is provided in a carrier which is suitable for topical application to skin or a mucous membrane of a mammal. Thus, the composition can be provided in the form of a milk, a lotion, a cream, an ointment, an oil, an ampoule, a mask, a gel, a pad, or a spray. The anti-bacterial compositions of the invention can be used in place of anti-bacterial agents that exert toxic or other undesired effects. Preservatives used in skin care can have adverse effects. Parabens, including methyl-, butyl-, ethyl-, and propyl-, often cause skin irritation, and there is concern that parabens may be linked to the development of breast cancer. Notably, parabens have been found in tissue samples from human breast tumors.

In addition, some preservatives release small amounts of formaldehyde, which the EPA classifies as a probable human carcinogen. The anti-bacterial composition of the inventions can replace or more of the following ingredients, all of which contain formaldehyde, release formaldehyde, or break down into formaldehyde: bronopol (often listed as 2-brono-2-nitropropane-1,3-diol); diazolidinyl urea; DMDM hydantion; imidazolidinyl urea; and quaternium 15.

The anti-bacterial compositions of the invention can be used to inhibit the growth of a variety of bacterial species, including Methicilin Resistant Staphylococcus aureus (“MRSA”), Streptococcus pyrogens, Escherichia coli, Pseudomonas aeruginosa, Staphylococcus aureus, (see Examples, below), and Clostridium spp, including Clostridium difficile. The compositions of the invention are thus suitable for treating or preventing nosocomial infections.

An anti-bacterial composition of the invention can be used to inhibit bacterial growth in a substance or area. In the method a composition comprising a safe and effective dose of an anti-bacterial extract obtained by extraction of plant material with an alkaline solution as described herein is contacted with a substance in which inhibition of bacterial growth is desired.

If desired, the method further includes assessing growth of bacteria on the substance. For example, the anti-bacterial composition according to the invention can be mixed with a food product, dermatological product or cosmetic product.

Similarly, the invention provides a method of inhibiting bacterial growth applying to an area on which it is desired to inhibit bacterial growth an effective dose of an anti-bacterial composition of the invention.

The invention further provides a method of preventing the formation or growth of a biofilm by applying to an area on which it is desired to prevent the formation or growth of biofilms an effective dose of an anti-bacterial composition of the invention.

Also within the invention is a method of preventing spoilage by applying to a product on which it is desired to prevent spoilage an effective amount an effective amount of a composition comprising a comprising a safe and effective dose of an anti-bacterial composition of the invention.

The invention additionally provides method for purifying a bacteriostatic or bactericidal agent. An extract obtained by extraction of plant material with an alkaline solution, preferably comprising one or more phenolic polymers is fractionated and fraction(s) are contacted with a bacterial cell population. The bacteriostatic effect or bactericidal effect, or both, of the tested fraction is determined, and fractions having desired bacteriostatic or bactericidal activity are isolated. Fractionation can be performed using separation methods known in the art.

The invention will be further illustrated in the following non-limiting examples.

### Example 1

### Purification of a Lyophilized Pine Cone Powder

A pine cone extract from P. silvestris is prepared according to the purification scheme shown in FIG. 1.

### Example 2

### Demonstration of Anti-Bacterial Activity in Purified Pine Cone Powder

A powder prepared according to the method shown in Example 1 was tested for the minimal inhibitory concentration inhibiting the growth of various bacteria. Each bacterial organism was prepared by inoculating the surface of a tryptic soy agar slant and incubating for 32±2.5° C. for 18 to 24 hours. Each fungal organism was prepared by inoculating the surface of subourand dextrose agar slants and incubated at 32±2.5° C. for a minimum of 48 hours. Following the incubation period the slants were washed with sterile saline to harvest the microorganism. The microbial suspension was adjusted to approximately 10⁷ to 10⁸ colony forming units (CFU) per ml and labeled as the stock suspension. This was further diluted to 1:200 in potato dextrose broth (PDB) to obtain a concentration of 10⁵ to 10⁶ CFU/ml. 25 grams of the powder was added to 100 ml sterile DI water to make a 1× sample.

For each organism to be tested 2 ml of the 1× sample was added to a first tube of a nine tube dilution series. To each remaining tubes, 1.0 ml of Muller-Hinton Broth was added. Using a sterile pipette, 1.0 ml of bacterial suspension was added to the first tube. To each remaining tube, 1.0 ml of the Mueller Hinton Broth was added. Using a sterile pipette, 1.0 ml of the first tube was transferred to the second tube. After vortexing, 1.0 ml of the second tube was transferred to the third tube. This was repeated for the remaining tubes in each dilution series. 1.0 ml of the bacterial suspension was added to each tube. The tubes were then incubated at 35±2.0° C. for 16 to 20 hours. A control tube was also prepared with 1.0 ml of bacterial inoculum. The control tube was incubated concurrently with the test samples. After incubation, each tube was examined for turbidity, which indicated growth.

The results are shown in the table below (G, Growth; NG, No Growth); Strains tested: Aspergillus niger (ATCC #16404); Escherichia coli (ATCC #11229): Pseudomonas aeruginosa (ATCC #9027); Staphylococcus aureus (ATCC #6538); Klebsiella pneumoniae (ATCC #10031); Candida albicans (ATCC #10231).

| | Molarity Drug Concentration (%) | | | | | | | | | | |
|---|---|---|---|---|---|---|---|---|---|---|---|
| | 50 | 25 | 12.5 | 6.25 | 3.13 | 1.56 | 0.78 | .0.39 | 0.19 | Control | MIC |
| Concentration of | 12.5 | 6.25 | 3.125 | 1.63 | 0.782 | 0.391 | 0.196 | 0.098 | 0.049 | N/A | N/A |
| Product (gms) | | | | | | | | | | | |
| Aspergillus niger | G | G | G | G | G | G | G | G | G | G | >50% |
| Escherichia coli | NG | G | G | G | G | G | G | G | G | G | 50% |
| Pseudomonas | NG | G | G | G | G | G | G | G | G | G | >50% |
| aeruginosa | | | | | | | | | | | |
| Staphylococcus | NG | NG | NG | NG | NG | G | G | G | G | G | 3.13% |
| aureus | | | | | | | | | | | |
| Klebsiella | NG | NG | NG | G | G | G | G | G | G | G | 12.5% |
| pneumoniae | | | | | | | | | | | |
| Candida albicans | G | G | G | G | G | G | G | G | G | G | >50% |

The powder was effective against Aspergillus niger and Candida albicans at an MIC concentration of greater than 50%, Escherichia coli and Pseudomonas aeroginosa at an MIC concentration of 50%, Staphylococcus aureus at an MIC concentration of 3.13% and Klebsiella pneumoniae at an MIC concentration of 12.5%.

### Example 3

### Bactericidal and Bacteriostatic Effects of Purified Pine Cone Powder

The bactericidal effects and bacteriostatic effects of a powder prepared as described in Example 1 were determined.

25 g of a powder product prepared as described in Example 1 was added to 100 mL of sterile DI water (“powder product solution”). Test bacterial organisms were prepared by inoculating the surface of tryptic soy agar slants. The microorganism was then incubated at 35.2±2.5° C. for 24 hours. Following the incubation period the slants were washed with sterile Phosphate Buffered Saline (PBS) to harvest the microorganisms. The microbial suspension was adjusted to approximately 10⁸ colony forming units (CFU) per mL and labeled as the stock suspension.

Bactericidal Study

A sample was prewarmed to 32° C. in water bath for 5 minutes. One milliliter of serum was added to 1.0 mL of approximately 10⁸ cells of the bacterial test culture and 8 mL of the powder product solution. The mixture as vortexed and incubated at 32° C. in a waterbath for 10 minutes. In triplicate, 1.0 mL was removed and diluted in Tryptic Soy Broth. 1:10 serial dilutions were performed to determine the number of microorganisms remaining. The control was performed with the same procedure, except that the powder product was omitted.

Bacteriostatic Study

A sample was prewarmed to 32° C. in a waterbath for 5 minutes. One milliliter of serum was added to 1.0 mL of approximately 10⁸ of bacterial test culture and 8 mL of the product. After vortexing in triplicate, 1.0 mL of the aliquot was pipette in 100 mL of TSB. This was incubated for 48 hours at 32° C. 1:10 serial dilutions were performed to determine the number of microorganisms remaining.

The control was performed with the same procedure as stated above except without the product.

The plates were incubated at 32.2±2.5° C. for minimum of 48 hours. After the incubation period, all plates were counted to determine the number of microorganisms remaining at each time point.

The results are shown below. The concentration of each microorganism for the control and product is listed for each interval. These numbers are expressed in terms of scientific notation. The next heading represents the “Log Reduction” information for each time point. The calculation is used to express the change (reduction or increase) of the microorganism population relative to a starting inoculum.

The Log₁₀ reduction is calculated as follows:

Log₁₀(initial count)−Log₁₀(x time interval)=Log₁₀reduction

The minimum bactericidal concentration is defined as 3 log reduction from the initial inoculum within 10 minutes at 32° C. in the 10% serum. For the bacteriostatic assay, the product must not show an increase of initial inoculum when incubated at 32° C. for 48 hours.

Bacteriocidal Assay Results:

| | | |
|---|---|---|
| Final Count | Percentage of | Log |
| (CFU/mL) | Reduction | Reduction |

ORGANISM: Methicillin Resistant Staphylococcus aureus,
ATCC# 33591

| | | | |
|---|---|---|---|
| Replicate #1 | 200 | | |
| Replicate #2 | 550 | | |
| Replicate #3 | 500 | | |
| Average of all | 420 | 99.99740% | 4.6 |
| replicates | | | |
| Control | 1.6E+07 | | |

ORGANISM: Streptococcus pyrogenes, ATCC# 19165

| | | | |
|---|---|---|---|
| Replicate #1 | <10 | | |
| Replicate #2 | <10 | | |
| Replicate #3 | <10 | | |
| Average of all | <10 | 99.99989% | 6.0 |
| replicates | | | |
| Control | 9.4E+06 | | |

ORGANISM: Escherichia coli, ATCC# 19165

| | | | |
|---|---|---|---|
| Replicate #1 | 150 | | |
| Replicate #2 | 95 | | |
| Replicate #3 | 150 | | |
| Average of all | 130 | 99.99918% | 5.1 |
| replicates | | | |
| Control | 1.6E+07 | | |

ORGANISM: Pseudomonas aeruginosa, ATCC# 9027

| | | | |
|---|---|---|---|
| Replicate #1 | 110 | | |
| Replicate #2 | 55 | | |
| Replicate #3 | 55 | | |
| Average of all | 73 | 99.99967% | 5.5 |
| replicates | | | |
| Control | 2.2E+07 | | |

ORGANISM: Staphylococcus aureus, ATCC# 6538

| | | | |
|---|---|---|---|
| Replicate #1 | 65 | | |
| Replicate #2 | 60 | | |
| Replicate #3 | 110 | | |
| Average of all | 78 | 99.99935% | 5.2 |
| replicates | | | |
| Control | 1.2E+07 | | |

Bacteriostatic Assay Results

| | |
|---|---|
| Final Count | |
| (CFU/mL) | Log Reduction |

ORGANISM: Methicillin Resistant Staphylococcus aureus,
ATCC# 33591

| | | |
|---|---|---|
| Replicate #1 | <10 | |
| Replicate #2 | <10 | |
| Replicate #3 | <10 | |
| Average of all | <10 | 8.1 |
| replicates | | |
| Control | 1.2E+09 | |

ORGANISM: Streptococcus pyrogenes, ATCC# 19165

| | | |
|---|---|---|
| Replicate #1 | <10 | |
| Replicate #2 | <10 | |
| Replicate #3 | <10 | |
| Average of all | <10 | 6.3 |
| replicates | | |
| Control | 2.1E+07 | |

ORGANISM: Escherichia coli, ATCC# 19165

| | | |
|---|---|---|
| Replicate #1 | 2.7E+08 | |
| Replicate #2 | 2.9E+08 | |
| Replicate #3 | 2.0E+08 | |
| Average of all | 2.5E+08 | 0.4 |
| replicates | | |
| Control | 6.9E+08 | |

ORGANISM: Pseudomonas aeruginosa, ATCC# 9027

| | | |
|---|---|---|
| Replicate #1 | 2.6E+08 | |
| Replicate #2 | 1.2E+08 | |
| Replicate #3 | 1.6E+09 | |
| Average of all | 6.6E+08 | −0.1 |
| replicates | | |
| Control | 5.5E+08 | |

ORGANISM: Staphylococcus aureus, ATCC# 6538

| | | |
|---|---|---|
| Replicate #1 | 1.7E+05 | |
| Replicate #2 | 6.1E+05 | |
| Replicate #3 | 2.8E+07 | |
| Average of all | 9.6E+06 | 2.1 |
| replicates | | |
| Control | 1.1E+09 | |

The results indicate that the powder has bactericidal activity against Methicilin Resistant Staphylococcus aureus, Streptococcus pyrogenes, Escherichia coli, Pseudomonas aeruginosa, and Staphylococcus aureus. The product prevented an increase of initial inoculum when incubated at 32° C. for 48 hours. The powder demonstrated bacteriostatic activity against Methicilin Resistant Staphylococcus aureus, Streptococcus pyrogenes, Escherichia. Coli and Staphylococcus aureus.

### Example 4

### Further Tests of Bacteriostatic and Bacteriostatic Activity

A PPC extract prepared as described in FIG. 1 was further characterized using FDA Bacteriostatic and Bactericidal Assay (Bioscreen Testing, Inc.), as described in the Federal Register Vol. 56, No 140/P Art 333.70 Section [d] [ii] and [iii].

Bacterial strains used included S. aureus (ATCC #6538), Methicillin Resistant S. aureus (MRSA), ATCC #33591, P. acnes (ATCC #6919), E. coli (ATCC #19165 and ATCC #6919).

Bacteria were cultured overnight, and subcultured for 6 hours until the bacteria reached a concentration of 1×10⁸/ml. The cells were centrifuged at 10,000×g to remove the culture media, and resuspended in water. PPC was added to 10⁸ bacteria and incubated for 10 min at room temperature with or without 10% serum. Assays used to measure killing included a plate spreading and colony counting assay and a fluorescence assay.

For the plate spreading and counting assay each concentration of PPC tested was serially diluted 1:10, eight times. 100 ul of each dilution was then spread onto an appropriate agar plate (LB, BHI, RCM) in triplicate. Colonies were counted at 24-48 hrs.

For the fluorometric Assay (BacLight, Molecular Probes) the cell dyes were added to the PPC/bacteria mixture and incubated a further 5 minutes, and the plate was then analyzed on the fluorometer.

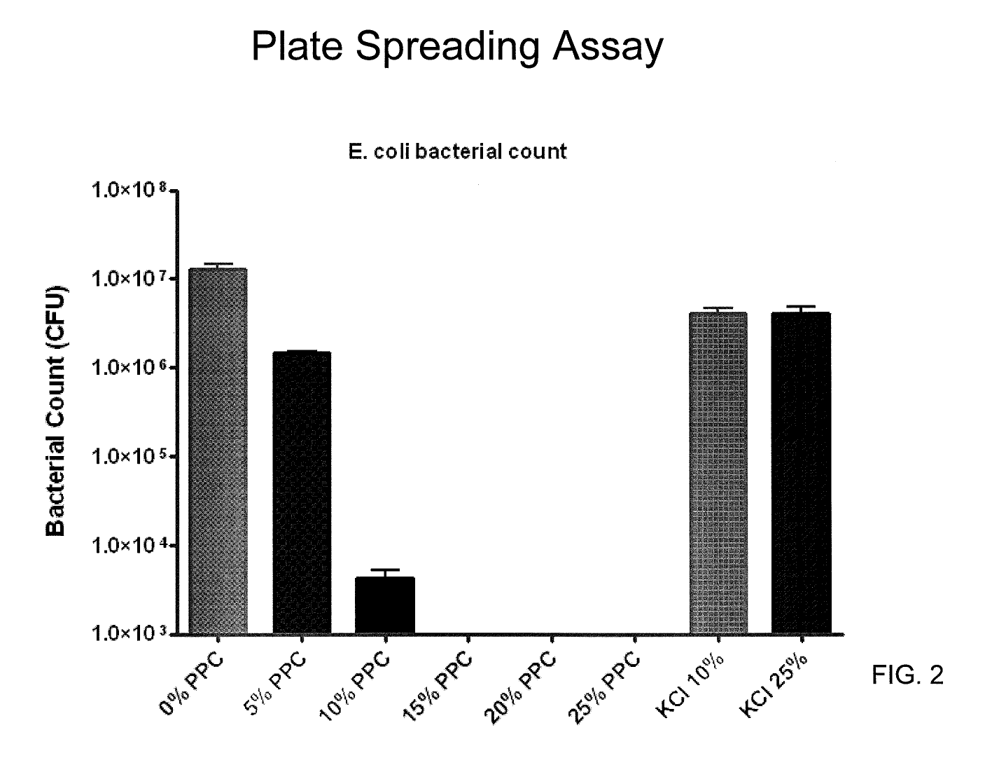

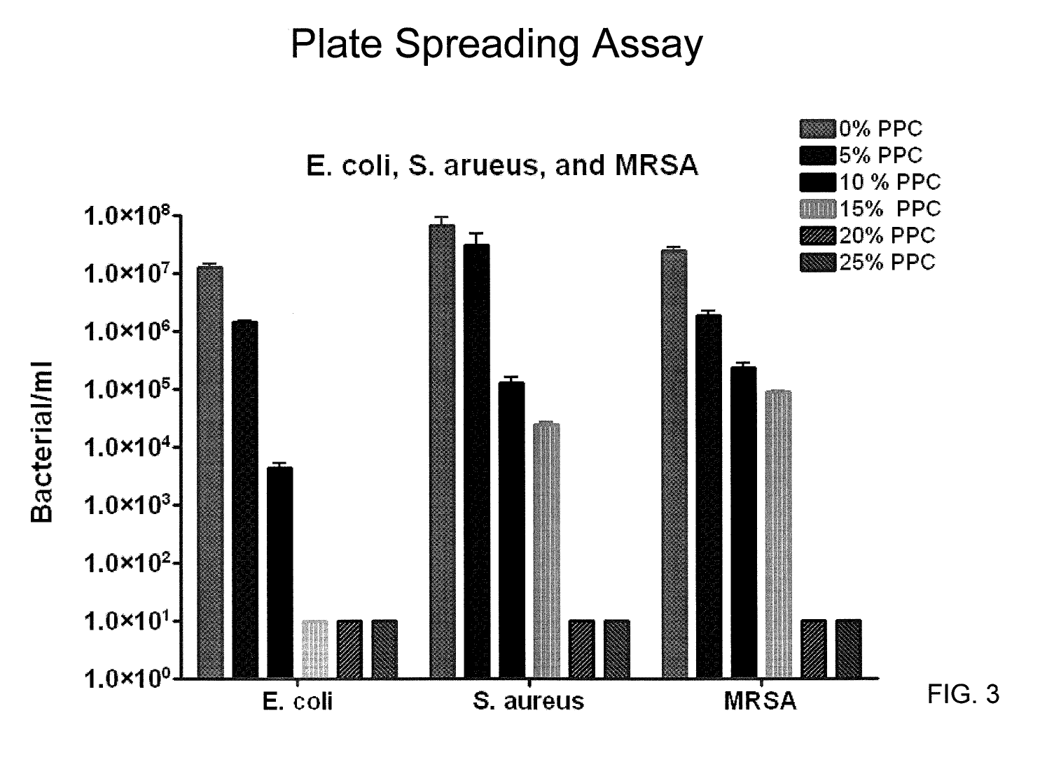

The results of the plate spreading assay are shown in FIG. 2 and FIG. 3. FIG. 2 demonstrates that the E. coli bacterial count decreased as the concentration of PPC increased from 0% to 25%. FIG. 3 shows that increases in PPC concentration from 0% to 25% lowered bacterial cell count for E. coli, S. aureus and MRSA.

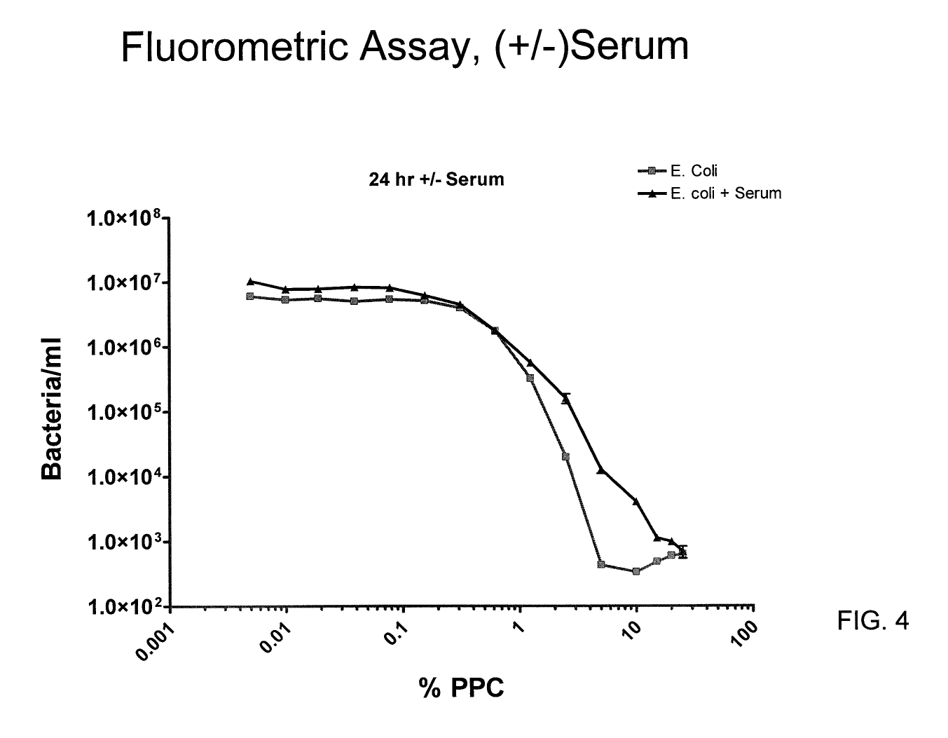

The effect of increasing amounts PPC on E. coli after 24 hours in the presence and absence of serum is shown in FIG. 4. The X-axis is a logarithmic scale showing increase in percentage PPC concentration. E. coli numbers decreased with increasing PPC in both the absence and presence of serum.

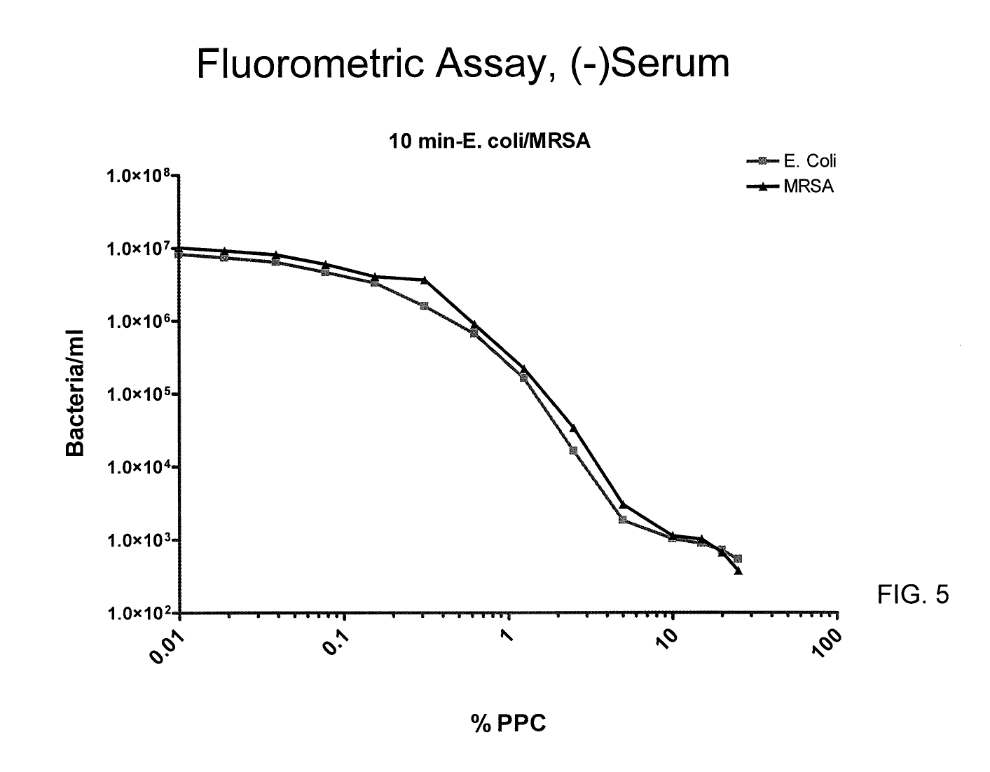

The effect of a ten minute treatment varied percentage concentrations of PPC was examined on E. coli and MRSA cells. The results are shown in FIG. 5. Both cell populations showed a decrease with increasing PPC concentration.

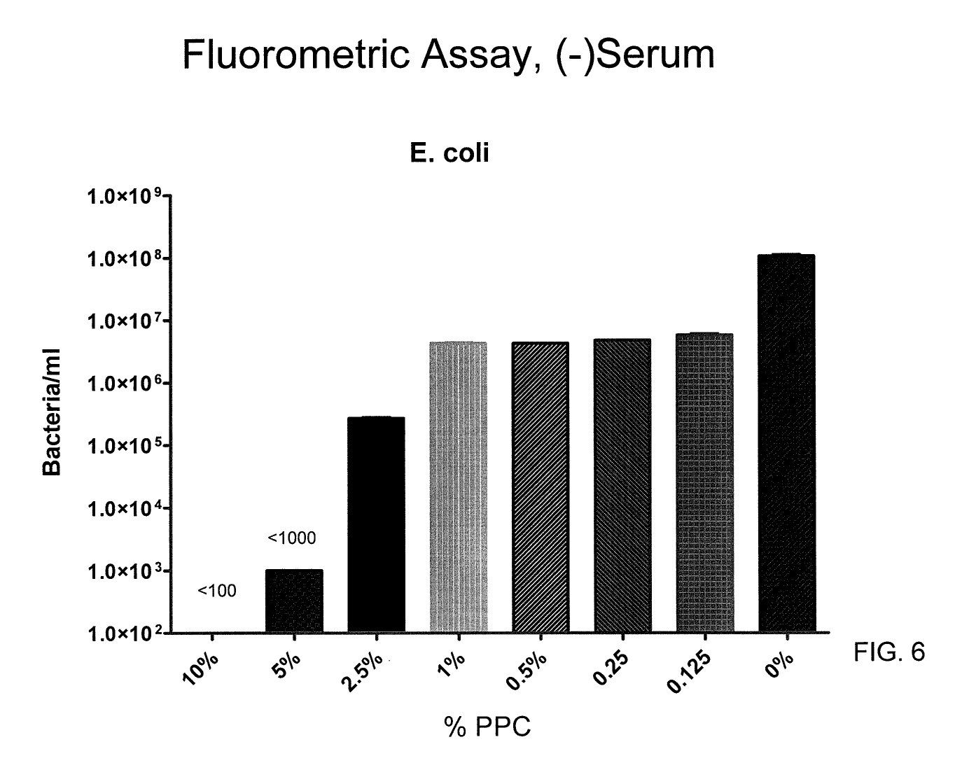

FIG. 6 is a histogram of a fluorometric assay showing E. coli/ml at decreasing concentrations of PPC (reading left to right). The bacterial count increased as the percentage of PPC decreased.

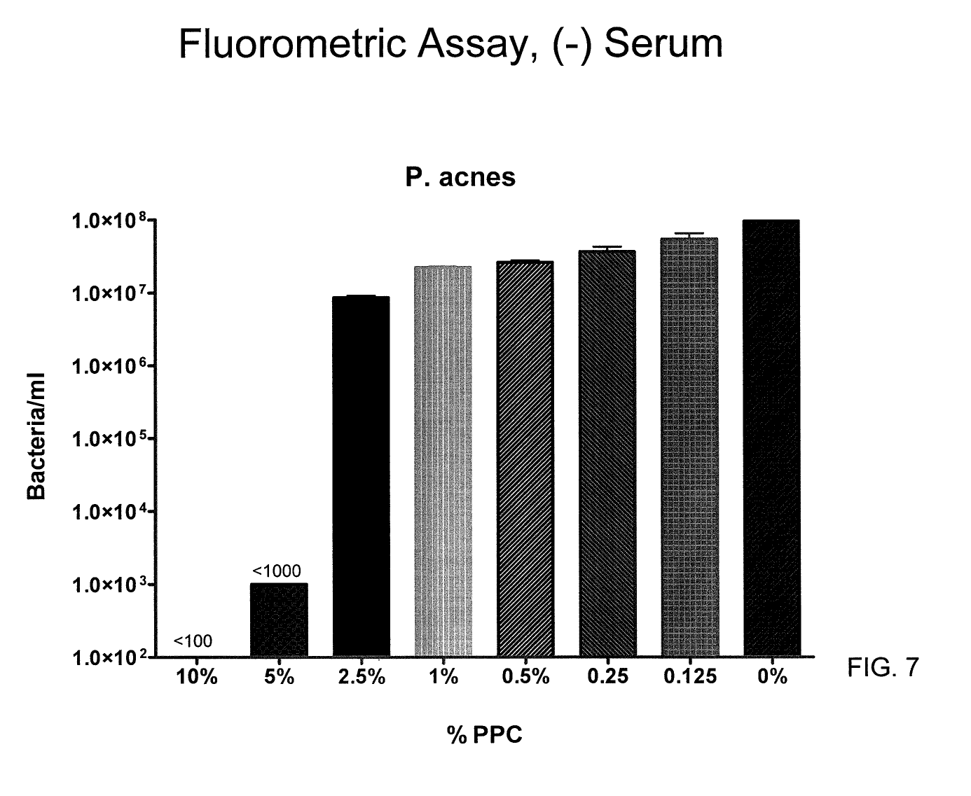

FIG. 7 is a histogram of a fluorometric assay showing increasing numbers P. acnes/ml at decreasing concentrations of PPC. Less inhibition was observed of P. acnes as compared to E. coli (compare FIG. 6 and FIG. 7).

### Example 5

### Cytotoxic Effects of PPC in a Fluorometric Assay

The effect of PPC in various formulations was also examined in a fluorometric assay. FIG. 7 is histogram showing the fluorometric assay results from comparing no PPC; 0.5% PPC in handwash (HW), 1% PPC in HW and 1% PPC in Cream on E. coli. PPC was as effective or more effective in inhibiting E. coli in hand wash.

The effect of PPC was also examined on various formulations of PPC against P. acnes in a fluorometric assay. Compared were 0. % PPC; HW 0.5% PPC-24; HW 1%-25; HW 0.5% PPC-26A, Cream 1%-PPC-27; and Cream 1%-28.

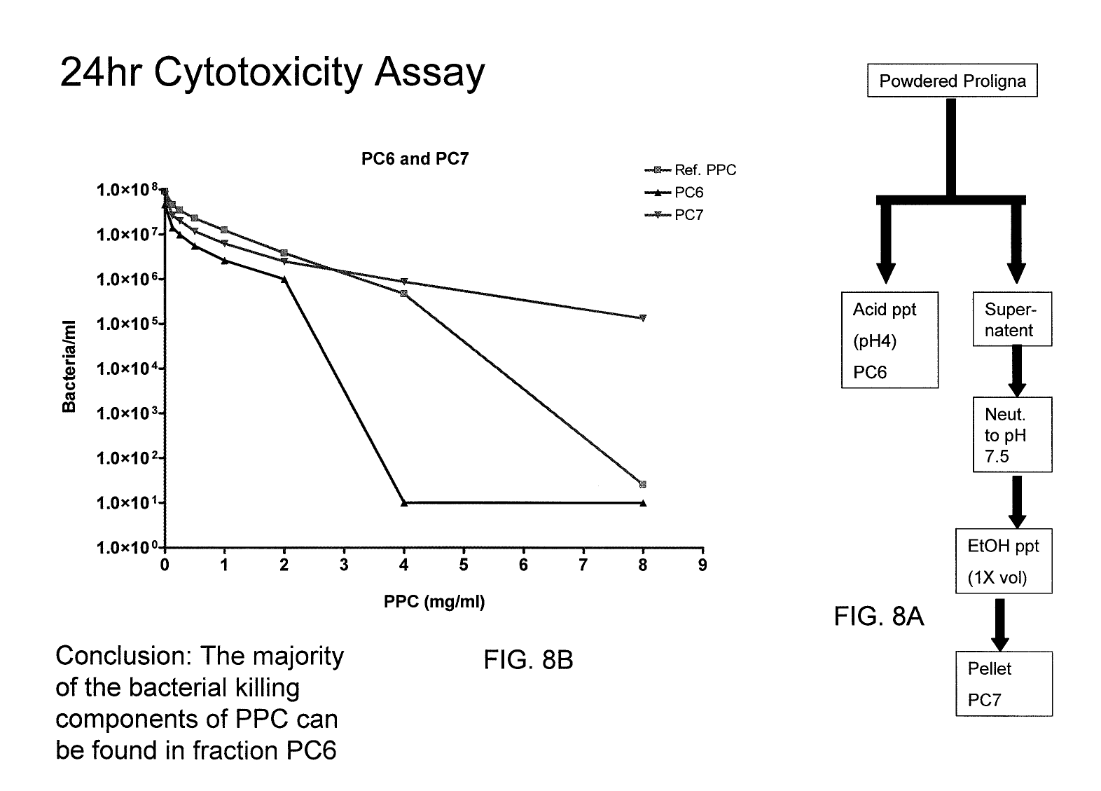

The cytotoxic activity was localized to an acid-precipitated fraction (PC6) and an acid-soluble fraction (PC7) using the strategy shown in FIG. 8A. The cytotoxic effects of fractions PC6 and PC7 were compared to the cytotoxic activity of an unfractionated PPC extract. The results are shown in FIG. 8B. The majority of the bacterial cytotoxic component of PPC was present in PC6.

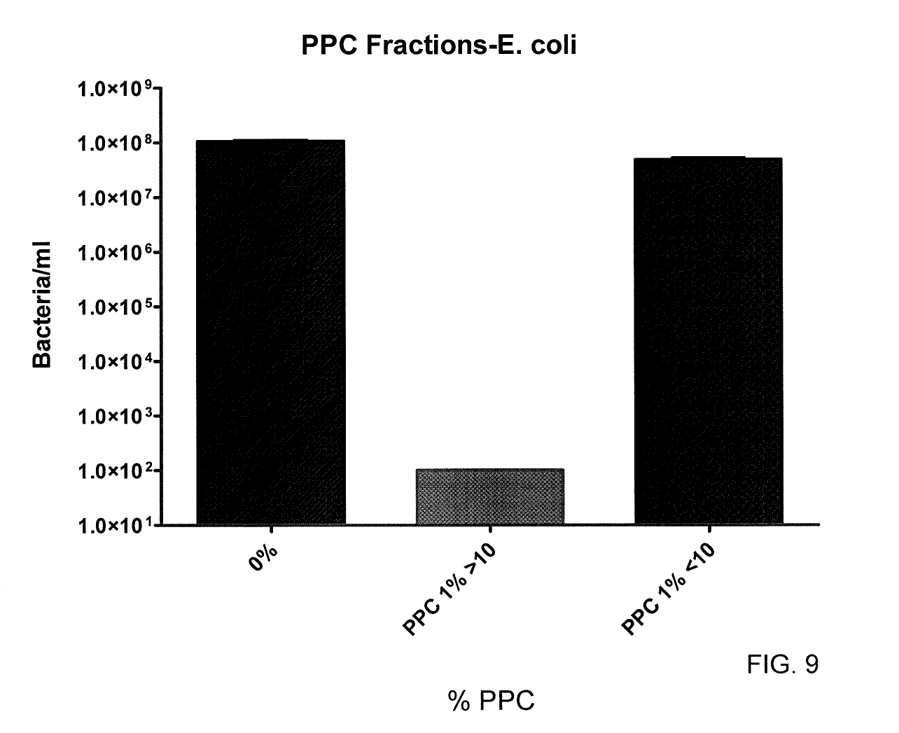

The effect of sized PPC fractions on inhibiting E. coli was examined. FIG. 9 is a histogram comparing no PPC (0%), PPC 1% fraction >10 kDA, and 1% PPC<10 kDa. The fractions were obtained by separating PPC extract fraction above 10 kilodaltons (kDa) and a fraction below 10 kDa using centrifugation through a 10 kDa filter. The filtrate and the retentate were resuspended in the original volume. These two size fractions were then tested for antibiotic activity.

The fraction of 1% PPC<10 showed some inhibition of bacteria, while PPC1%>10 showed strong inhibition. These data indicate that the large molecular weight fraction of the extract (greater than 10 kDa) is responsible for the majority of the antibiotic effect.

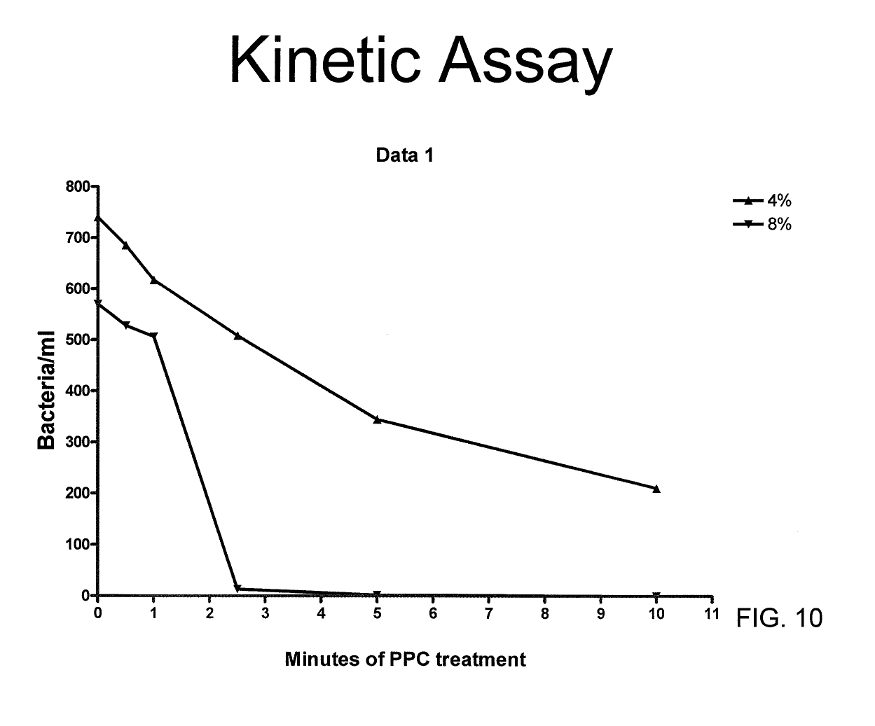

FIG. 10 shows the results of a kinetic assay measuring bacteria/ml as a function of minutes of PPC treatment. An 8% PPC solution lowered the bacteria/ml count to almost zero within three minutes, while a 4% PPC solution lowered the bacteria/ml count from slightly over 700/ml to just over 200 bacteria/ml at t=10 minutes.

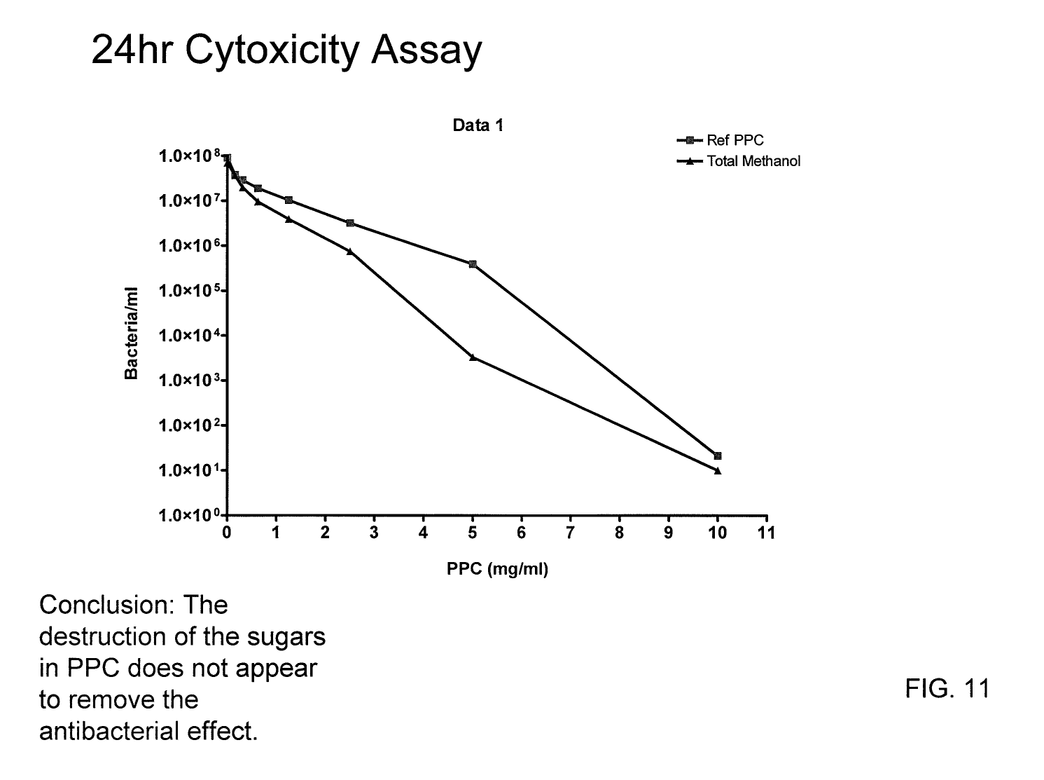

The effect of destroying sugars on PPC on its cytotoxic activity was determined by treating the PPC with methanol. The result is shown in FIG. 11. The methanol-treated PPC was effective in a 24 hour cytotoxicity assay, showing that destroying the sugars in PPC did no remove its bacterial effect.

### Example 6

### Topical Cosmetic Formulations Containing PPC

The activity of PPC was examined when present in various topical formulations.

PPC exhibits a distinctive color and following initial screening potential avenues to reduce color intensity of emulsions were initiated following client request. Titanium dioxide (T-LITE) was selected as an acceptable ‘whitening agent’ and incorporated into the formulae. A hydrophilic polymer, hydroxyethyl cellulose (HEC) was included at various concentrations to enhance viscosity of the aqueous phase of the emulsions, thereby reducing the sedimentation rate of T-LITE. The effect of HEC concentration and process on the stability of the emulsions was investigated.

Seven cream (Table 1) and three hand-wash (Table 4) compositions were prepared, and their physical stability was assessed using appearance and pH over 4 weeks with freeze thaw cycling (F/T), 5° C., 25° C. and 40° C. as the test conditions.

Appearance and pH of the emulsions, (Table 2 and 3) after 4 weeks indicated that increasing polymer HEC concentration from 0 to 0.75% w/w improved physical stability. Formula 2847-20 contained the highest polymer content (0.75% w/w) and did not exhibit. evidence of phase separation after exposure to each storage condition for 4 weeks. The pH of the cream formulae was stable at F/T, 5° C., and 25° C. A slight decrease of approximately 0.3 pH units was observed after 4 weeks at 40° C. Utilization of buffer system rather than water may provide tighter control of the pH.

TABLE 1
Cream composition table and physical stability over 4 weeks

| | Formula ID 2847- | | | | | | |
|---|---|---|---|---|---|---|---|
| | 19 | 20 | 21 | 22 | 23 | 27 | 28 |
| Component | % w/w | | | | | | |
| Propylene Glycol | 5 | 5 | 5 | 5 | 5 | 5 | 5 |
| Polysorbate 80 | 1 | 1 | 1 | 1 | 1 | 1 | 1 |
| Titanium Dioxide (T-LITE Max) | 2 | 2 | 2 | 2 | 2 | 2 | 2 |
| HEC | | 0.75 | | 0.5 | 0.25 | 0.5 | 0.25 |
| Deionized Water | 69.2 | 68.45 | 64.9 | 68.2 | 68.45 | 68.3 | 68.55 |
| Methylparaben | 0.15 | 0.15 | | 0.15 | 0.15 | 0.15 | 0.15 |
| Propylparaben | 0.05 | 0.05 | | 0.05 | 0.05 | 0.05 | 0.05 |
| PPC Drug Substance | 0.5 | 0.5 | 5 | 1 | 1 | 1 | 1 |
| Emulsifying Wax | 12 | 12 | 12 | 12 | 12 | 12 | 12 |
| Mineral Oil | 2 | 2 | 2 | 2 | 2 | 2 | 2 |
| Cetyl Alcohol | 3 | 3 | 3 | 3 | 3 | 3 | 3 |
| White Petrolatum | 5 | 5 | 5 | | | | |
| Cyclomethicone | | | | 5 | 5 | 5 | 5 |
| Vitamin E | 0.1 | 0.1 | 0.1 | 0.1 | 0.1 | | |
| Total | 100.00 | 100.00 | 100.00 | 100.00 | 100.00 | 100.00 | 100.00 |

TABLE 2

| | Formula ID 2847- | | | | | | |
|---|---|---|---|---|---|---|---|
| | 19 | 20 | 21 | 22 | 23 | 27 | 28 |
| t = 0, Initial | Light brown | Light | Dark brown | Light brown | Light brown | Light brown | Light brown |
| | | brown | | | | | |
| t = 4 weeks | | | | | | | |
| F/T | Small amount | NC | very small amount | NC | NC | NC | NC |
| | of darker area | | phase separation | | | | |
| | @ bottom | | | | | | |
| 5° C. | NC | NC | Very small amount | NC | NC | NC | NC |
| | | | phase separation | | | | |
| 25° C. | NC | NC | NC | NC | NC | NC | NC |
| 40° C. | Very small | NC | Small amount phase | Very small | Very small | Very small | Very small |
| | amount phase | | separation | amount phase | amount phase | amount phase | amount phase |
| | separation | | | separation | separation | separation | separation |

N/C—No change from initial sample

TABLE 3
Emulsion pH at initial and 4 week time points

| | Formula ID 2847- | | | | | | |
|---|---|---|---|---|---|---|---|
| | 19 | 20 | 21 | 22 | 23 | 27 | 28 |
| t = 0, R/t | 7.00 | 7.01 | 7.47 | 7.31 | 7.49 | 7.40 | 7.35 |
| t = 4 weeks | | | | | | | |
| F/T | 6.93 | 6.92 | 7.32 | 7.51 | 7.40 | 7.41 | 7.38 |
| 5° C. | 6.96 | 7.03 | 7.55 | 7.49 | 7.44 | 7.38 | 7.39 |
| 25° C. | 6.92 | 6.97 | 7.19 | 7.34 | 7.36 | 7.24 | 7.24 |
| 40° C. | 6.72 | 6.61 | 7.07 | 6.95 | 7.07 | 6.99 | 6.90 |

TABLE 4
Hand-wash composition table

| | | Formula ID 2847- | | |
|---|---|---|---|---|
| | | 24 | 25 | 26A |
| | Component | % w/w | | |
| A | Deionized Water, Part I | 10 | 10 | 10 |
| | Glycerin | 1 | 1 | 1 |
| | Sodium laureth-3 sulfate (Steol CS-330) | 30 | 30 | 30 |
| | Disodium laurethsulfosuccinate | 20 | 20 | 20 |
| | (Stepan mild SL3-BA) | | | |
| | Cocoamidopropyl betaine (Amphosol CG) | | | 5 |
| B | Deionized Water, Part II | 25 | 25 | 25 |
| | PPC Drug Substance | 0.5 | 1 | 0.5 |
| C | Sodium hydroxide (10% w/w solution) | QS | QS | QS |
| | Citric acid | QS | QS | QS |
| D | Sodium Chloride (add 1-3% - for viscosity | 3.0 | 3.0 | 3.0 |
| | adjustment) | | | |
| E | Deionized Water, Part III | QS | QS | QS |
| | Total | 100 | 100 | 100 |

Evidence of precipitation in hand-wash formulae after 4 weeks at 25° C. (Table 5) was detected. Precipitate was observed in all hand-wash formulae after four weeks at 40° C. This may be related to an interaction between the surfactants and the PPC. It may be possible to optimize surfactant and PPC concentration to reduce precipitation potential; however, experimental confirmation would be required. The pH of the formulae decreased over time (Table 6), especially at 40° C. From a physical stability perspective emulsion compositions appear superior to the hand-wash formulae based on current compositions.

TABLE 5
Visual Observation of hand-wash formulae
at initial and 4 week time points

| Formula ID 2847- | | |
|---|---|---|
| 24 | 25 | 26A |

| | |
|---|---|
| t = 0, Initial | Dark solution |
| t = 4 weeks | |
| F/T | NC |
| 5° C. | NC |
| 25° C. | very small amount of ppt. @ bottom |
| 40° C. | small amount of ppt. @ bottom |

TABLE 6
pH of hand-wash formulae at initial and 4 week time points

| | Formula ID 2847- | | |
|---|---|---|---|
| | 24 | 25 | 26A |
| t = 0, R/T | 7.1 | 7.18 | 7.34 |
| t = 4 weeks | | | |
| F/T | 6.53 | 6.5 | 6.78 |
| 5° C. | 6.71 | 6.63 | 7.08 |
| 25° C. | 6.45 | 6.38 | 6.61 |
| 40° C. | 5.94 | 5.94 | 6.1 |

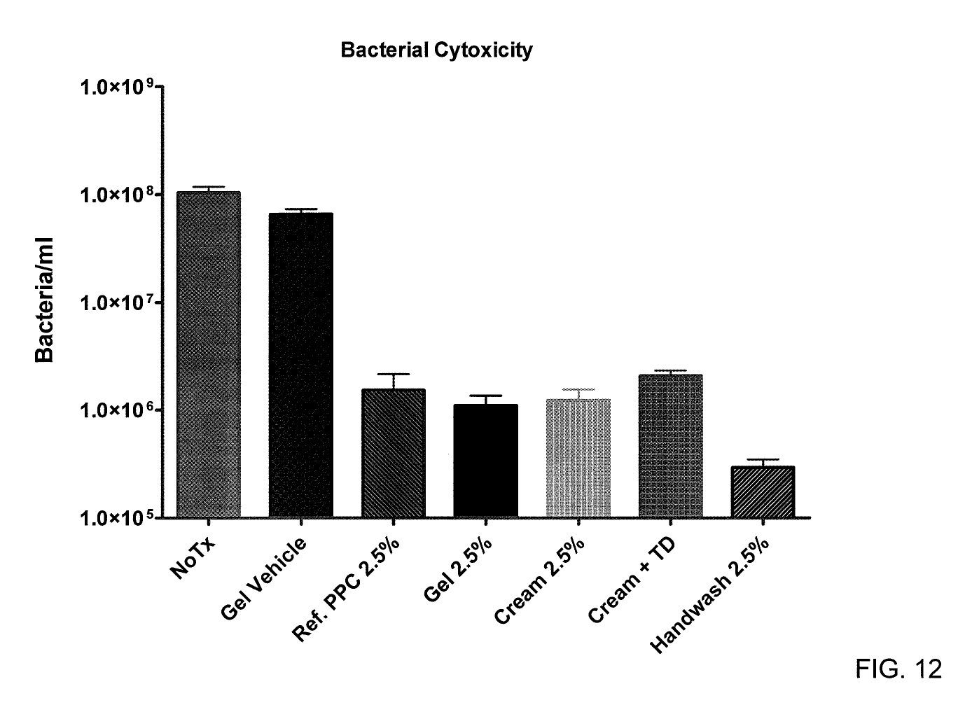

FIG. 12 is a histogram showing the results of examining the bacterial cytotoxicity of PPC when combined with other substances. Shown are bacteria/ml following no treatment (NoTx); gel vehicle alone (no PPC), 2.5% PPC, 2.5% PPC with gel; 2.5% PPC and cream; and cream+TD. PPC was as cytotoxic or more cytotoxic than when administered alone when combined with gel, cream, or handwash.

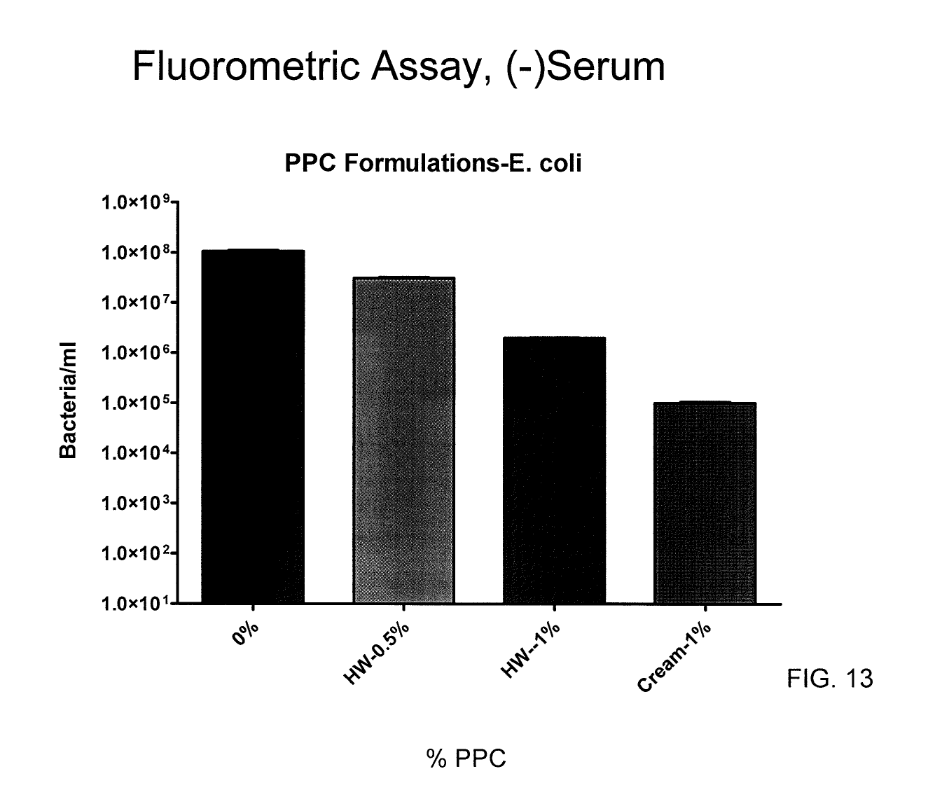

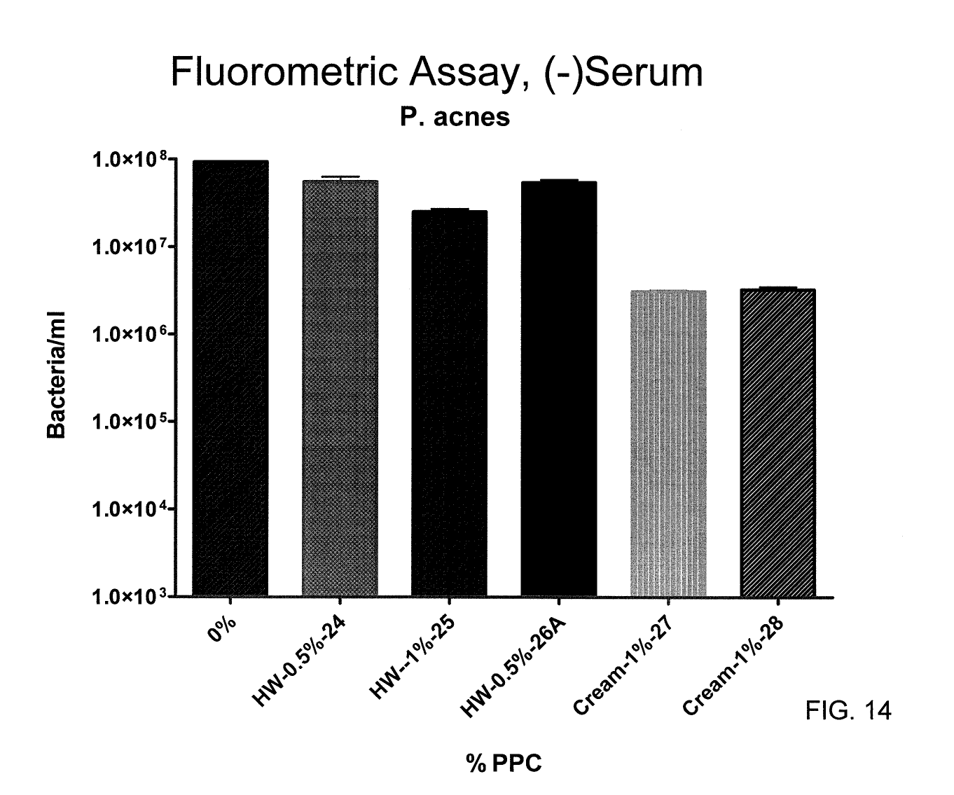

FIG. 13 (E. coli) and FIG. 14 (P. acne) are histograms showing the results of fluorometric assays showing bacteria/ml and handwash or cream at the indicated concentrations of PPC. PPC lowered the bacterial count in all conditions tested.

Additional embodiments are within the claims.

What is claimed is:

1. A composition useful for inhibiting the growth of bacteria, said composition comprising a safe and effective dose of a bacteriostatic or bactericidal extract obtained by extraction of plant material with an alkaline solution,
wherein said extract comprises one or more phenolic polymers; and
wherein said composition is provided in a carrier which is suitable for topical application to skin or a mucous membrane of a mammal.

2. The composition of claim 1, wherein said composition is provided in a pharmaceutically-acceptable carrier.

3. The composition of claim 1, wherein said plant material is selected from the group consisting of leaves, needles, bark, stalks, sheath and cones.

4. The composition of claim 1, wherein said plant material is harvested from a plant selected from the group consisting of a magnolia tree, bamboo tree, palm tree, Spanish moss, orange pekoe tea, pekoe black tea, green tea, mountain araucaria, and bushy bluestem.

5. The composition of claim 1, wherein said extract is extracted from pine cones of any variety or species of genus Pinus.

6. The composition of claim 5, wherein the pine cone is selected from the group consisting of P. silvestris, P. densiflora, P. koraiensis, P. parviflora and P. thunbergii.

7. The composition of claim 5, wherein the pine cone is P. silvestris.

8. The composition of claim 1, wherein the alkaline solution comprises an alkaline agent selected from aluminum hydroxide, magnesium hydroxide, aluminum hydroxide/magnesium hydroxide co-precipitate, aluminum hydroxide/sodium bicarbonate co-precipitate, aluminum glycinate, calcium acetate, calcium bicarbonate, calcium borate, calcium carbonate, calcium citrate, calcium gluconate, calcium glycerophosphate, calcium hydroxide, calcium lactate, calcium phthalate, calcium phosphate, calcium succinate, calcium tartrate, dibasic sodium phosphate, dipotassium hydrogen phosphate, dipotassium phosphate, disodium hydrogen phosphate, disodium succinate, magnesium acetate, magnesium aluminate, magnesium borate, magnesium bicarbonate, magnesium carbonate, magnesium citrate, magnesium gluconate, magnesium hydroxide, magnesium lactate, magnesium metasilicate aluminate, magnesium oxide, magnesium phthalate, magnesium phosphate, magnesium silicate, magnesium succinate, magnesium tartrate, potassium acetate, potassium carbonate, potassium bicarbonate, potassium borate, potassium citrate, potassium hydroxide, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium sesquicarbonate, sodium succinate, sodium tartrate, sodium tripolyphosphate, synthetic hydrotalcite, tetrapotassium pyrophosphate, tetrasodium pyrophosphate, tripotassium phosphate, trisodium phosphate, and mixtures thereof.

9. The composition of claim 1, wherein the alkaline solution comprises an alkaline agent at a concentration of about 0.1% to about 5% w/w.

10. The composition of claim 1, wherein the alkaline solution comprises an alkaline agent at a concentration of about 0.1% to 2% w/w.

11. The composition of claim 1, wherein the alkaline solution has a pH of at least about 8.

12. The composition of claim 1, wherein the alkaline solution has a pH of about 11 to about 13.

13. The composition of claim 1, wherein said alkaline solution comprises potassium.

14. The composition of claim 1, wherein said extract has been extracted with potassium hydroxide having at least a pH of 8.

15. The composition of claim 1, wherein said potassium hydroxide has a pH of from 6 to 8.

16. The composition of claim 1, wherein the active component of said extract is a polyphenylpropenoid-polysaccharide complex (PPC).

17. The composition of claim 1, wherein the polyphenylpropenoid-polysaccharide complex (PPC) has a brown color with an absorption shoulder at 260-280 nm, which dissolves in water and alcohol, and acetone, and is composed of a complex of polysaccharides and polyphenylpropenoids, with the five major components having a molecular weight of greater than about 100, 21.0, 13.5, 3.6 and 2.1 kilodaltons as determined by fast protein liquid chromatography, said polyphenylpropenoid-polysaccharide complex (PPC) being obtained from the precipitate from potassium hydroxide extract of pine cone at pH 7.

18. The composition of claim 1, wherein said extract is provided lyophilized.

19. A dermatological and cosmetic composition, said composition comprising a safe and effective dose of a bacteriostatic or bactericidal extract obtained by extraction of plant material with an alkaline solution,
wherein said extract comprises one or more phenolic polymers; and
wherein said composition is provided in a carrier which is suitable for topical application to skin or a mucous membrane of a mammal.

20. A method of inhibiting bacterial growth in a substance, the method comprising contacting a substance in which inhibition of bacterial growth is desired a composition comprising a safe and effective dose of a bacteriostatic or bactericidal extract obtained by extraction of plant material with an alkaline solution,
wherein said extract comprises one or more phenolic polymers.
